(19) United States
(12) Patent Application Publication
(10) Pub. No.: US 2025/0314028 A1
(43) Pub. Date: Oct. 9, 2025

(54) DEVICE FOR AUTOMATICALLY COLLECTING AND TRANSPORTING WASTE ON ROAD

(71) Applicants: Jun Woo LEE, Incheon (KR); Sang Hyeon LEE, Incheon (KR)

(72) Inventors: Jun Woo LEE, Incheon (KR); Sang Hyeon LEE, Incheon (KR)

(21) Appl. No.: 18/750,307

(22) Filed: Jun. 21, 2024

(30) Foreign Application Priority Data
Apr. 5, 2024 (KR) 10-2024-0046474

(51) Int. Cl. E01H 1/10; B25J 9/16; B25J 11/00

(52) U.S. Cl. CPC E01H 1/106; B25J 9/162; B25J 9/1697; B25J 11/0085

(57) ABSTRACT

The present disclosure may provide a device for automatically collecting and transporting waste on the road that automates the collection of trash and waste abandoned on the road through the convergence technology of software and hardware to improve the speed of collection of large trash or waste, removes the causes and risks of accidents that may occur during manual collection work on existing roads, and does not require a separate operator to operate the collection mechanism, thereby reducing labor costs.

### CROSS-REFERENCE TO RELATED APPLICATION(S)

This application claims priority to Korean Patent Application No. 10-2024-0046474 filed in the Korean Intellectual Property Office on Apr. 5, 2024, the disclosure of which is incorporated by reference herein in its entirety.

### TECHNICAL FIELD

An embodiment of the present disclosure relates to a device for automatically collecting and transporting waste on the road based on artificial intelligence image recognition technology.

### DISCUSSION OF RELATED ART

As an inevitable result of the rapid expansion and increase of cities and roads after the Industrial Revolution, the rapid increase in the use of various artificial materials, and the advancement of sophistication, it has become an important task for cities to efficiently dispose of large amounts of trash and waste dumped in cities and on roads.

In the conventional work of collecting road waste, a method was applied in which workers manually collect trash or waste discarded on the road surface using tongs or the like while crossing the road.

However, manual collection of such trash and waste inevitably causes accidents on highways where vehicles are traveling at high speeds.

In addition, the manual work of collecting trash cannot be performed quickly, which has the disadvantage of deteriorating the driving environment on the road.

In order to solve the conventional problem of collecting trash and waste dumped on roads, large amounts of trash are collected using large-sized vehicles so that trash and waste can be disposed of systematically and mechanically. However, large-sized vehicles used in the collection of such trash and waste have difficulty handling large trash or waste beyond the level of collecting small trash on the road.

In these cases, collection work is carried out manually or through the manipulation of mechanical devices directly by the worker using a separate cargo vehicle, and at this time, there is a disadvantage that additional labor costs are incurred in that a worker skilled in operating the machine must work together.

### SUMMARY

Embodiments of the present disclosure provide a device for automatically collecting and transporting waste on the road that automates the collection of trash and waste abandoned on the road through the convergence technology of software and hardware to improve the speed of collection of large trash or waste, removes the causes and risks of accidents that may occur during manual collection work on existing roads, and does not require a separate operator to operate the collection mechanism, thereby reducing labor costs.

A device for automatically collecting and transporting waste on road according to an embodiment of the present disclosure comprises a cargo vehicle equipped with a loading box, and an automatic collection device including: a driving unit installed in the loading box and driven to pick up waste on the road and put the waste down in the loading box according to a drive control signal; a capturing unit capturing images at an angle according to movement of the driving unit; and a controller performing a deep learning-based object recognition algorithm on the image captured by the capturing unit, specifying the location of the recognized object, generating the driving control signal according to the specified object location, and transmitting the driving control signal to the driving unit.

Further, the driving unit may comprise a robot arm, and the robot arm may include a manipulator combining multiple links and joints to enable multi-axis joint rotation, a gripper coupled to the wrist of the manipulator, and a robot controller receiving the drive control signal from the controller and controlling the operation of the manipulator and the gripper, respectively.

Further, the capturing unit may be installed in the wrist of the manipulator.

Further, the capturing unit may be installed on the driving unit.

Further, the controller may include an object image extraction unit removing a background image from the captured image of the capturing unit based on an object extraction model to extract an object image, an object image recognition unit classifying and recognizing the type of the object image from the object image based on an object recognition model, an object coordinate data acquisition unit acquiring two-dimensional coordinate data of an object image, recognized by the object image recognition unit, in the captured image of the capturing unit, a capturing posture data acquisition unit acquiring posture data of the driving unit when acquiring captured images of the capturing unit, and a driving control signal generator generating the driving control signal based on the coordinate data and the posture data.

In addition, the robot arm may further include a vacuum suction drive assembly performing a collection operation through vacuum suction of the remaining waste whiling colleting the waste, and the vacuum suction drive assembly may include a vacuum suction port formed at the center of the bottom surface of the gripper, a motor fan assembly generating suction force and driving the waste to be sucked through the vacuum suction port, a vacuum suction pipe connected between the vacuum suction port and the motor fan assembly, and a vacuum discharge pipe connected to the motor fan assembly to discharge the sucked waste.

In addition, the controller may include an object area and number calculation unit calculating the area and number of object images on a two-dimensional plane, respectively, and the vacuum suction drive assembly may further include a motor fan controller controlling whether to operate the motor fan assembly when one or more suction conditions selected from the first suction condition in which the area of the object images calculated through the object area and number calculation unit is smaller than the predetermined reference area and the second suction condition in which the number of object images is greater than the predetermined reference number are satisfied.

A device for automatically collecting waste on road according to another embodiment of the present disclosure comprises a driving unit installed in a loading box of a cargo vehicle and driven to pick up waste on the road and put the waste down in the loading box according to a drive control signal, a capturing unit capturing images at an angle according to movement of the driving unit, and a controller performing a deep learning-based object recognition algorithm on the image captured by the capturing unit, specifying the location of the recognized object, generating the driving control signal according to the specified object location, and transmitting the driving control signal to the driving unit.

The present disclosure may provide a device for automatically collecting and transporting waste on the road that automates the collection of trash and waste abandoned on the road through the convergence technology of software and hardware to improve the speed of collection of large trash or waste, removes the causes and risks of accidents that may occur during manual collection work on existing roads, and does not require a separate operator to operate the collection mechanism, thereby reducing labor costs.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating a device for automatically collecting and transporting waste on the road and its overall implementation according to an embodiment of the present disclosure;

FIG. 2 is a block diagram showing the overall basic configuration of a device for automatically collecting and transporting waste on the road according to an embodiment of the present disclosure;

FIG. 3 is a view showing the external configuration of a device for automatically collecting and transporting waste on the road according to an embodiment of the present disclosure;

FIG. 4 is a block diagram showing the configuration of a driving unit (robot arm) according to an embodiment of the present disclosure;

FIG. 5 is a block diagram showing the configuration of a vacuum suction drive assembly according to an embodiment of the present disclosure; and

FIG. 6 is a block diagram showing the configuration of a controller according to an embodiment of the present disclosure.

### DETAILED DESCRIPTION OF EXEMPLARY EMBODIMENTS

The terms used in this specification will be briefly described, and the present disclosure is described in detail.

The terms used in the present disclosure have been selected from general terms that are currently widely used as much as possible while considering the functions in the present disclosure, but these may vary depending on the intention of a person skilled in the art or precedent, the emergence of new technologies, and the like. In a specific case, there is also a term arbitrarily selected by the applicant, and in this case, the meaning will be described in detail in the description of the invention. Therefore, the term used in the present disclosure should be defined based on the meaning of the term and the overall content of the present disclosure, not simply the name of the term.

When it is said that a certain part “includes” a certain component throughout the specification, it means that it may further include other components, not excluding other components unless otherwise stated. Further, terms such as “ . . . unit” and “module” described in the specification mean a unit that processes at least one function or operation, which may be implemented as hardware or software or a combination of hardware and software.

Hereinafter, with reference to the accompanying drawings, embodiments of the present disclosure will be described in detail so that those skilled in the art can easily carry out the present disclosure. However, the present disclosure may be embodied in many different forms and is not limited to the embodiments described herein. In order to clearly describe the present disclosure in the drawings, parts irrelevant to the description are excluded, and similar reference numerals are assigned to similar parts throughout the specification.

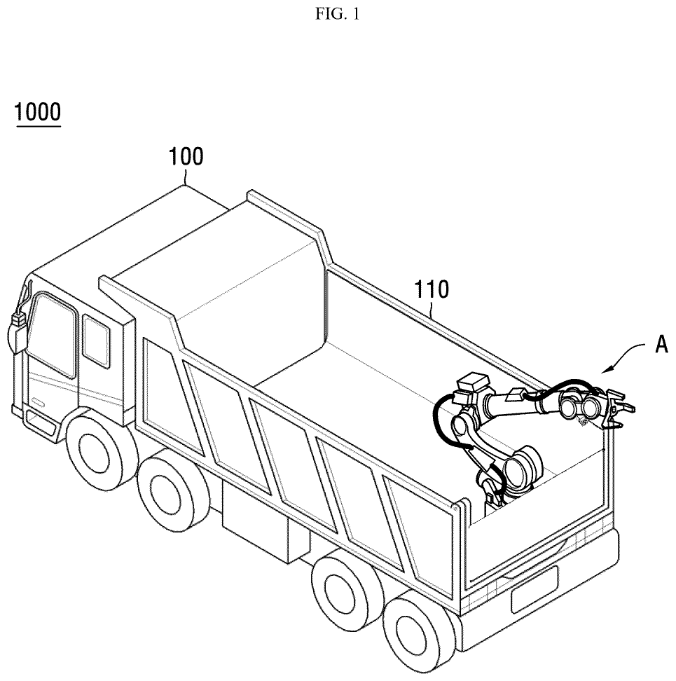

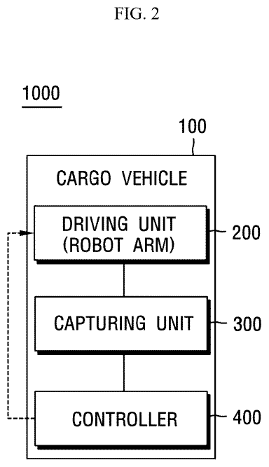

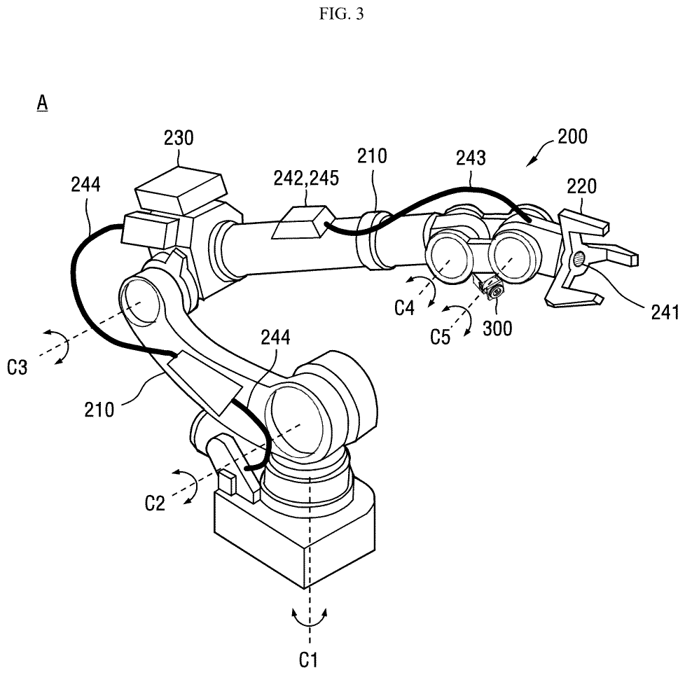

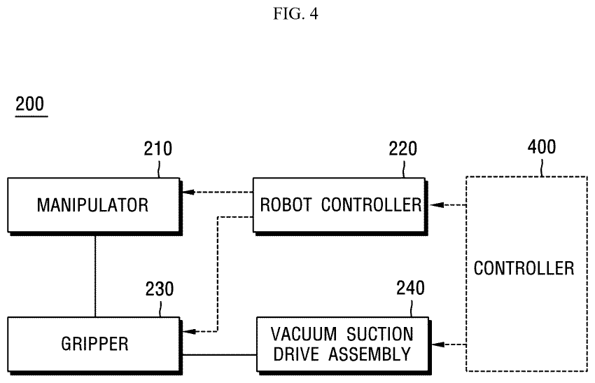

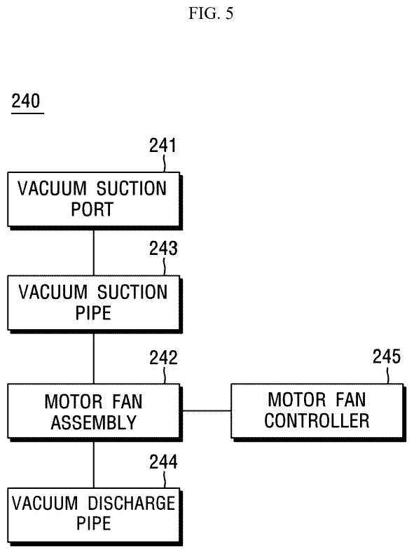

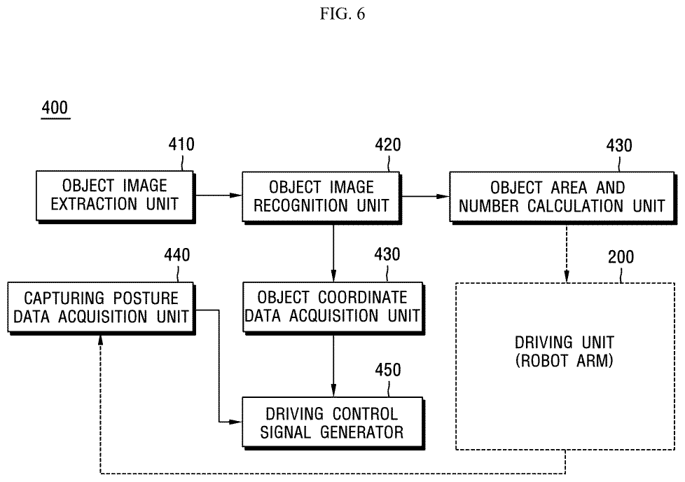

FIG. 1 is a view illustrating a device for automatically collecting and transporting waste on the road and its overall implementation according to an embodiment of the present disclosure, FIG. 2 is a block diagram showing the overall basic configuration of a device for automatically collecting and transporting waste on the road according to an embodiment of the present disclosure, FIG. 3 is a view showing the external configuration of a device for automatically collecting and transporting waste on the road according to an embodiment of the present disclosure, FIG. 4 is a block diagram showing the configuration of a driving unit (robot arm) according to an embodiment of the present disclosure, FIG. 5 is a block diagram showing the configuration of a vacuum suction drive assembly according to an embodiment of the present disclosure, and FIG. 6 is a block diagram showing the configuration of a controller according to an embodiment of the present disclosure.

Referring to FIGS. 1, 2, and 3, the device for automatically collecting and transporting waste on road 2000 according to an embodiment of the present disclosure may include at least one of a cargo vehicle 100, a driving unit 200, a capturing unit 300, and a controller 400, but the device may be implemented as a separate device (A) for collecting trash or wastes so that it consists of a driving unit 200, a capturing unit 300, and a control unit 400.

The cargo vehicle 100 may be provided with a loading box 110 where trash or waste is stored or loaded.

The driving unit 200 may be implemented as a robot arm configuration installed in the loading box 110 of the cargo vehicle 100, and the driving unit 200 may be driven to pick up trash or waste on the road according to a drive control signal received from the controller 400 to put-down in the loading box 110 of the cargo vehicle 100.

To this end, the driving unit 200 may include at least one of a manipulator 210, a gripper 220, a robot controller 230, and a vacuum suction drive assembly 240, as shown in FIG. 4.

The manipulator 210 may be a geometric structure configured to enable multi-axis joint rotation by combining a plurality of links and joints, and it may be connected to the gripper 220 at the wrist at its distal end and to be driven according to the drive control of the robot controller 230. The manipulator 210 of this embodiment may have a 5-axis structure consisting of five links/joints (C1 to C5), as shown in FIG. 3. and a bi-directional drive motor may be installed at each of the five links/joints (C1 to C5) to enable joint rotation drive in a certain direction and angle under the control of the robot controller 230, thereby moving the gripper 220 to the location of the trash and then moving it back to the loading box 110. Here, control of the robot controller 230 for the manipulator 210 may mean controlling the rotation of each joint of the manipulator 210 based on a drive control signal from the controller 400.

The gripper 220 may be coupled to the wrist of the manipulator 200 and be modularized and detachable from the wrist of the manipulator 200. Accordingly, it can be replaced with a suitable module depending on the characteristics such as size and type of the collection target, including trash or waste. The gripper 220 according to this embodiment may be composed of 3 to 4 index fingers. Here, control of the robot controller 230 for the gripper 220 may mean controlling joint driving for pinching and unfolding of the gripper 220 based on a drive control signal from the controller 400.

Meanwhile, a vacuum suction port 241 may be formed on the bottom surface (palm portion) of the gripper 220, and an additional process of fastening a vacuum suction pipe 243 to the vacuum suction port 241 is required when reconnecting due to replacement of the gripper 220.

The robot controller 230 may receive a drive control signal from the control unit 400 and control the driving of the manipulator 210 and the gripper 220, respectively, based on the received drive control signal.

Further, the robot controller 230 may obtain posture data or posture information of the manipulator 210 in conjunction with the capturing unit 300. More specifically, at the time the photographing unit 300 captures the image, it determines the rotation direction and rotation angle for each of the bi-directional drive motors for each of the five links/joints (C1 to C5) of the manipulator 210, generates joint rotation drive state information, generates capturing posture data based on the generated joint rotation drive state information and provide it to the controller 400.

Meanwhile, the robot controller 230 may transmit a capturing control signal to the capturing unit 300 when the posture of the manipulator 210 is initialized, and in this case, rather than determining the posture of the manipulator 210 at the time of capturing of the capturing unit 300, the posture of the manipulator 210 may be set to the basic value and then a capturing instruction is given. Accordingly, the basic posture data of the manipulator 210 may be transmitted to the controller 400 so that more accurate posture data can be provided than if the posture of the manipulator 210 is determined at the time of capturing.

A vacuum suction drive assembly 240 may perform a collection operation through vacuum suction of remaining trash or waste while collecting trash or waste.

To this end, as shown in FIG. 5, the vacuum suction drive assembly 240 may include at least one of a vacuum suction port 241, a motor fan assembly 242, a vacuum suction pipe 243, a vacuum discharge pipe 244, and a motor fan controller 245.

The vacuum suction port 241 may be formed at the center of the bottom surface of the gripper 220. Accordingly, when the gripper 220 approaches the location of the trash or waste, or when the gripper 220 grasps the trash or waste, the trash or waste that is relatively small in size may be easily sucked in from a position close to it. This vacuum suction port 241 may be connected to one end of the vacuum suction pipe 243.

The motor fan assembly 242 may be driven to generate suction force and suck relatively small trash or waste through the vacuum suction port 241. This motor fan assembly 242 may be connected to other end of the vacuum suction pipe 243.

The vacuum suction pipe 243 may be connected between the vacuum suction port 241 and the motor fan assembly 242 and may serve to guide small trash or waste introduced through the vacuum suction port 241 in the direction of the motor fan assembly 242, i.e. the direction in which the suction force acts.

The vacuum discharge pipe 244 may be connected to the motor fan assembly 242 so that the small-sized trash or waste introduced toward the motor fan assembly 242 may be discharged to a specific location or space. For example, when the vacuum discharge pipe 244 is positioned toward the loading box 110 of the cargo vehicle 100, the sucked small trash or waste is collected in the corresponding loading box 110, or when it is connected to a separate housing (for example, storage member), small trash or waste may be collected in the housing.

A motor fan controller 245 may control whether to operate the motor fan assembly 242 when one or more suction conditions selected from the first suction condition in which the area of the object images calculated through an object area and number calculation unit 460 is smaller than the predetermined reference area and the second suction condition in which the number of object images is greater than the predetermined reference number are satisfied.

More specifically, the first suction condition is performed by comparing the area of the object image (A1), which is the area calculated based on the number of pixels of the object image recognized as a type of trash or waste, and the reference area (B1) based on the predetermined reference number of pixels, and as a result, if the area of the object image (A1) is smaller than the reference area (B1), it may be defined as satisfying the condition, and if not, it may be defined as not satisfying the condition.

More specifically, the second suction condition is performed by determining how many object images recognized as types of trash or waste are recognized in the entire image and then comparing the identified number (A2) with the predetermined reference number (B2), and if the number of the object image (A2) is greater than the reference number (B2), it may be defined as satisfying the condition, and if not, it may be defined as not satisfying the condition.

The motor fan controller 245 may be configured to set the case where only the first suction condition is satisfied and the case where only the second suction condition is satisfied, or the case where both the first and second suction conditions are satisfied as options, and the motor fan assembly 242 may be controlled to determine whether to operate or not depending on whether the suction condition is satisfied according to the corresponding setting option.

Meanwhile, the motor fan controller 245 may operate for a preset basic time when the motor fan assembly 242 is operated, but is not limited to this, and the operation time may be flexibly adjusted according to the results of the first suction condition and/or the second suction condition. For example, a preset first operation time may be determined depending on how much the area of the object image (A1) is greater than the reference area (B1) (i.e., excess range), and a preset second operation time may be determined depending on how much the number of object images (A2) is greater than the reference number (B2) (i.e., excess range). At this time, when the adjusted first operation time and second operation time need to be applied, the operation time of the motor fan assembly 242 may be adjusted by setting it to the average time of the first operation time and the second operation time.

The capturing unit 300 may capture images at an angle according to the movement of the driving unit 200. For this purpose, the capturing unit 300 may be installed on the driving unit 200, and more specifically, may be installed on the wrist of the manipulator 210. When the capturing unit 300 receives a capturing control signal from the robot controller 230, a capturing operation such as a video or photo is performed, and the captured image may be transmitted to the controller 400. As the capturing unit 300 according to this embodiment, it is preferable that a capturing means optimized for a deep learning-based object recognition process, such as an RGB camera, is applied.

The controller 400 may perform a deep learning-based object recognition algorithm on the captured image of the capturing unit 300, specifies the location of the recognized object, and generates a drive control signal according to the specified object location, and transmits it to the driving unit 200.

To this end, as shown in FIG. 6, the controller 400 may include at least one of an object image extraction unit 410, an object image recognition unit 420, an object coordinate data acquisition unit 430, a capturing posture data acquisition unit 440, a driving control signal generator 450, and an object area and number calculation unit 460.

The object image extraction unit 410 may extract an object image by removing the background image from the captured image of the capturing unit 300 based on a deep learning-based object extraction model.

More specifically, the object image extraction unit 410 may extract only the object image from an image including the object image and the background image through a deep learning-based object extraction model and perform preprocessing on the image. Thereafter, the object image extraction unit 410 may divide the image into a plurality of unit pixels and generate a first feature map corresponding to the plurality of unit pixels. Thereafter, the object image extraction unit 410 may reduce the dimension of the first feature map a number of times and expand the dimension of the first feature map whose dimension has been reduced a number of times. At this time, the object image extraction unit 410 may reduce the dimension of the first feature map n times and expand the dimension of the first feature map whose dimension has been reduced n times n times. Here, n is a natural number greater than or equal to 1, and the maximum value may be s. Further, when the object image extraction unit 410 expands the dimension of the first feature map n times, the dimension of the first feature map may be expanded by using a feature map that combines a first feature map whose dimension is expanded n−1 times and a first feature map whose dimension is reduced s−n+1 times.

Thereafter, the object image extraction unit 410 may generate a segmentation map indicating whether a plurality of unit pixels are objects from the first feature map whose dimensions have been expanded a plurality of times. Here, the segmentation map may include location information indicating the location of each of a plurality of unit pixels within the image and information about whether it is an object indicating whether the unit pixel is an object. For example, if the unit pixel of location information (2,1) is an object, the information about whether it is an object at the (2,1) location may be set to 1 in the segmentation map, and if the unit pixel of location information (2,1) is not an object, the information about whether it is an object at the (2,1) location may be set to 0 in the segmentation map. Thereafter, the processor 220 may extract unit pixels indicating that the object information about whether it is an object is an object and extract it as an object image.

It may be implemented as a deep learning-based object extraction model “U-Net” model according to this embodiment, but the type of object extraction model is not limited in this way as long as an object image can be extracted from an image.

The object image recognition unit 420 may classify and recognize the type of object image (trash or waste) from the object image based on a deep learning-based object recognition model.

More specifically, the object image recognition unit 420 may generate object recognition data by recognizing the type of object represented by the object image from the object image through a deep learning-based object recognition model, and a second feature map for the object image may be generated through the backbone module of the object recognition model. That is, an object image may be input as input data to the backbone module of the object recognition model, and the second feature map may be output as output data.

Thereafter, the object image recognition unit 420 may recognize the type of object represented by the object image based on the second feature map through the head module of the object recognition model and then generate object recognition data. That is, the second feature map may be input as input data to the head module of the object recognition model, and the object recognition data may be output as output data. Here, the object recognition data may be data about the type of object represented by the object image.

The deep learning-based object recognition model according to this embodiment may be an artificial intelligence model implemented as a “YoLo” model consisting of a backbone module and a head module, the backbone module as a “ResNet50” model, and the type of object recognition model is not limited in this way as long as the type of object represented by the object image can be recognized.

Meanwhile, as a result of object recognition, if it is a living organism such as a person or an animal, the object image recognition unit 420 separately recognizes it as a special object and provides a separate notification to the manager or worker before the collection operation is performed so that it allows accurate confirmation of the collection environment to be preceded.

The object coordinate data acquisition unit 430 may acquire two-dimensional coordinate data of an object image recognized through the object image recognition unit 420 in the captured image of the capturing unit 300.

Since the trash or waste to be collected according to this embodiment is statically placed without moving on the ground (road), when coordinate data for the collection target is obtained from a still image, it is easy to calculate whether subsequent operation of the manipulator 210, that is, any movement to pick up the collection object from the current posture. is required. Accordingly, the coordinate data may include the two-dimensional coordinate values for the midpoint or the center point of the recognized object.

The capturing posture data acquisition unit 440 may acquire posture data of the driving unit 200 when acquiring a captured image of the capturing unit 300.

As described above, at the time when the capturing unit 300 captures the image, the robot controller 230 may determine the rotation direction and rotation angle for each of the bi-directional drive motors for each of the five links/joints (C1 to C5) of the manipulator 210, generate joint rotation drive state information, generate capturing posture data based on the generated joint rotation drive state information, and then the capturing posture data acquisition unit 440 may acquire it.

Meanwhile, the capturing posture data acquisition unit 440 may acquire basic posture data of the manipulator 210 from the robot controller 230 in place of the capturing posture data.

The driving control signal generator 450 may generate a drive control signal based on coordinate data and posture data (capturing posture data or basic posture data) and transmit it to the driving unit 200.

The driving control signal generator 450 may identify what posture the manipulator 210 is taking at the time (or initial stage) of capturing by each bidirectional motor configured in the driving unit 200 based on the posture data (capturing posture data or basic posture data), and based on this, it generates a drive control signal calculated in which direction and by how much each bi-directional motor should rotate in order to switch or change the posture for moving the gripper 220 to the target position according to the coordinate data. The drive control signal generated in this way is applied to the corresponding bi-directional motor according to each identification information by the robot controller 230, and then the posture of the manipulator 210 may be changed or controlled so that the gripper 220 can move to the position intended by the drive control signal.

The object area and number calculation unit 460 may calculate the area and number of object images on a two-dimensional plane, respectively. In other words, the area of the pixels for the object image (object area) recognized on the two-dimensional plane composed of the captured image is calculated, the number of corresponding pixels is counted, and data on the area and number of the object images may be generated, and the generated data may be provided to the motor fan controller 245 and used as data to determine the first and second suction conditions described above.

According to the present disclosure, it may automate the collection of trash and waste through the convergence technology of software and hardware to improve the speed of collection of large trash or waste, remove the causes and risks of accidents that may occur during manual collection work on existing roads, and not require a separate operator to operate the collection mechanism, thereby reducing labor costs.

The above description is only for one embodiment for implementing an exemplary device for automatically collecting and transporting waste on road according to the present disclosure. The present disclosure is not limited to the above embodiment. As claimed in the claims below, it is understood that the technical spirit of the present disclosure exists to the extent that various changes can be made by those skilled in the art without departing from the gist of the present disclosure.

What is claimed is:

1. A device for automatically collecting and transporting waste on road, the device comprising:
a cargo vehicle equipped with a loading box; and
an automatic collection device including: a driving unit installed in the loading box and driven to pick up waste on the road and put the waste down in the loading box according to a drive control signal; a capturing unit capturing images at an angle according to movement of the driving unit; and a controller performing a deep learning-based object recognition algorithm on the image captured by the capturing unit, specifying the location of the recognized object, generating the driving control signal according to the specified object location, and transmitting the driving control signal to the driving unit.

2. The device of claim 1, wherein the driving unit comprises a robot arm, and
wherein the robot arm includes a manipulator combining multiple links and joints to enable multi-axis joint rotation; a gripper coupled to the wrist of the manipulator; and a robot controller receiving the drive control signal from the controller and controlling the operation of the manipulator and the gripper, respectively.

3. The device of claim 2, wherein the capturing unit is installed in the wrist of the manipulator.

4. The device of claim 1, wherein the capturing unit is installed on the driving unit.

5. The device of claim 1, wherein the controller includes:
an object image extraction unit removing a background image from the captured image of the capturing unit based on an object extraction model to extract an object image;
an object image recognition unit classifying and recognizing the type of the object image from the object image based on an object recognition model;
an object coordinate data acquisition unit acquiring two-dimensional coordinate data of an object image, recognized by the object image recognition unit, in the captured image of the capturing unit;
a capturing posture data acquisition unit acquiring posture data of the driving unit when acquiring captured images of the capturing unit; and
a driving control signal generator generating the driving control signal based on the coordinate data and the posture data.

6. A device for automatically collecting waste on road, the device comprising:
a driving unit installed in a loading box of a cargo vehicle and driven to pick up waste on the road and put the waste down in the loading box according to a drive control signal;
a capturing unit capturing images at an angle according to movement of the driving unit; and
a controller performing a deep learning-based object recognition algorithm on the image captured by the capturing unit, specifying the location of the recognized object, generating the driving control signal according to the specified object location and transmitting the driving control signal to the driving unit.
